(19) United States
(12) Patent Application Publication
(10) Pub. No.: US 2009/0286065 A1
(43) Pub. Date: Nov. 19, 2009

(54) METHOD FOR GENERATING SUPRAMOLECULAR ROTARY DEVICES AND SUPRAMOLECULAR ROTARY SWITCH

(75) Inventors: Davide Bonifazi, Guastalla (IT); Fuyong Cheng, Hamilton (CA); Francois Diederich, Dietikon (CH); Thomas Jung, Thalwil (CH); Andreas Kiebele, Aesch (CH); Hannes Spillmann, Zurich (CH); Nikolai Wintjes, Basel (CH)

Correspondence Address: LERNER GREENBERG STEMER LLP, P O BOX 2480, HOLLYWOOD, FL, 33022-2480, US

(73) Assignee: Paul Scherrer Institut, Villigen (CH)

(21) Appl. No.: 12/373,865

(22) PCT Filed: Jul. 6, 2007
(86) PCT No.: PCT/EP2007/006008

§ 371 Date: Jan. 14, 2009

Related U.S. Application Data
(60) Provisional application No. 60/831,111, filed on Jul. 14, 2006.

(51) Int. Cl. B32B 3/26; B05D 5/00

(52) U.S. Cl. 428/315.5; 427/245; 428/304.4

(57) ABSTRACT

A method for generating a porous network of supra-molecular devices includes the steps of: a) providing self-organizing molecules comprising connecting bonds and side-groups; b) generating a two-dimensional layer of the molecules on an unstructured surface, wherein self-organizing leads to an at least partially regular network of cells, each cell comprising a number of said self-organizing molecules and each cell offering a functional center; and c) further depositing a predefined amount of said self-organizing molecules and/or of other functional molecules on said two-dimensional layer, wherein these further deposited molecules accommodating in said functional centers of said cells, one or more of said further deposited molecules per cell, wherein said further deposited molecule comprises a multi-stable architecture together with the cell hosting the further deposited molecule. This method provides a rotary switch that offers on a large scale a bottom-up self assembly of the self-organizing molecules that result in a nanoporous network with single supra-molecular switches that can be addressed individually and switched by changing its orientation. Such rotary switch is at low cost a very flexible and powerful nanodevice that can be largely used in molecular electronic applications, such as for the purpose of storing information.

The present invention relates to a method for generating a porous network of supramolecular mechanical devices and to its use. Further, the present invention relates to a porous network of supramolecular mechanical devices and to its use.

In recent years, devices characterized by their multi-stable behaviour have been strongly in the focus of research. Herein, the approaches were manifold: Chemists developed highly sophisticated synthetic strategies that allowed for the construction of various bi- or multi-stable molecules in solution and the bulk state. Triggered by external stimuli such as photons or electric fields, electronic and conformational states or these (interlocked) molecules can be switched reversibly. On solid surfaces, physicists induced reversible conformational changes and isomerization of single molecules with local probe techniques such as Scanning Tunneling Microscopy (STM) or Atomic Force Microscopy (AFM). Apart from these purely intramolecular switches, it has recently been shown that by manually placing individual molecules via STM into specific arrangements on surfaces highly complex and functional logical circuits can be engineered. These entities reflect examples of supramolecular switches which can be operated on the molecular level and are based on the interplay between single molecules.

Unfortunately, so far it was not possible to provide highly complex supramolecular switches that can be fabricated by a natural self-engineering process without further need for manual construction.

It is therefore an objective of the present invention to provide a method for generating a porous network of supramolecular mechanical devices and a porous network of supramolecular mechanical devices that avoid the aforementioned drawbacks.

These objectives are achieved by a method for generating a porous network of supramolecular mechanical devices, comprising the steps of:

a) providing self-organizing molecules comprising connecting bonds and side-groups;
b) generating a two-dimensional layer of said molecules on an unstructured surface, wherein self-organizing leads to an at least partially regular network of cells, each cell comprising a number of said self-organizing molecules and each cell offering a functional center; and
c) further depositing a predefined amount of said self-organizing molecules and/or of other functional molecules on said two-dimensional layer, wherein these further deposited molecules accommodating in said functional centers of said cells, one or more of said further deposited molecules per cell, wherein said further deposited molecule comprises a multi-stable architecture together with the cell hosting the further deposited molecule.

This method provides a rotary device that offers on a large scale a bottom-up self assembly of the self-organizing molecules that result in a nanoporous network comprising single supramolecular devices that can be addressed individually and switched by changing molecular orientation. Such rotary switching device is at low cost a very flexible and powerful nanodevice that can be largely used in molecular electronic applications, such as for the purpose of storing information or for the purpose of generating intelligent functional surfaces with switching surface for transport, reflectivity, emissivity or absorption purposes taking benefit from the multi-stable architecture.

According to a preferred embodiment of the present invention, the multi-stable architecture is designed to allow at least two different status of the further deposited molecule together with the hosting cell in view of its electronic, mechanic, opto-electronic and/or opto-mechanic properties.

The self-organizing molecules can preferably be selected from a group containing porphyrin, porphyrin derivates, coronenes, coronene derivates, phtalo-cyanines, phtalo-cyanine derivates, deca-cyclines and deca-cycline derivates. Said compounds show due to their planar intra-molecular binding structure a large affinity to self-assemble in two dimensional structures when functionalized accordingly.

Appropriate properties of the side group are definitely required for the self-assembly of the ring-shaped structures. Therefore, preferred side groups that offer to direct the inter-molecular binding of the molecules are, for example, polar groups or hydrogen bonds. Hydrogen bonding can be achieved by arrays with one, two, three and up to four hydrogen bonds. Other preferred sidegroups are multipolar interactions such as CN . . . CN, C═O . . . CO bindings or weak hydrogen bonds formed by C—H groups, in particular aromatic C—H such as C—H . . . NC, CH . . . N (pyridine). Further, also halogen bonding (CN . . . X (X=S, Cl, Br, I) or C═O . . . X and N (pyridine . . . X) with X the same as in the first case can be considered to be valuable. And last but not least, quadrupolar interactions such as phenyl . . . perfluorphenyl can be also considered as possible sidegroup binding mechanisms.

As an preferred embodiment of the present invention the self-organizing molecules may be specially designed porphyrin molecules that arrange in a way that the polar group of a side-group of one porphyrin molecule points to a polar group of a side-group of a neighboring porphyrin molecule. This means in a further preferred embodiment that the side group is a cyano-phenyl porphyrin molecule points to the center of the phenyl ring of the cyano-phenyl group of a neighboring porphyrin molecule.

Furthermore, the unstructured surface is also essential for the deposition of the self-organizing molecules and their self-organizing capabilities. Therefore, the unstructured surface is preferably selected from a group containing metallic surfaces, ionic surfaces, ceramic surfaces and any mixtures of the foregoing surfaces. For an example, the unstructured surface is a metallic crystal surface being [001] or [111]-oriented surface, such as a Cu surface. Further, the unstructured surface can be an ionic crystalline NaCl and/or KCl surface. Furthermore, the unstructured surface is a silicon surface, preferably passivated by hydrogen fluoride treatment or similar [the same surface is achieved if—in the vacuum H2 is dosed to the freshly prepared Si(111)].

To address the supramolecular rotary switching devices, a preferred embodiment of the method according to the invention may switch the orientation of the molecule accommodated in the nanopore center by an electric stimulation of said molecule at a predefined temperature or at a temperature below a predefined temperature. For example, said molecule may be stimulated by a local probe as they are contained in STM (Scanning tunneling microscopy) or SFM (Scanning Force Microscopy) instruments. The probe thereby induces energy into the addressed device, which is pre-determined to induce switching processes between different states of the device entity.

With respect to an optimized relationship between the amount of nanopore centers available to be occupied by further deposited molecules, it has shown that the amount of further deposited molecules shall be preferably less or equal to the amount required for one mono-layer. Therefore, any effect according over-occupation of the nanopore centers, stacking of molecule and the like can be thus eliminated.

Further preferred embodiment of the present invention can be taken from the remaining dependent claims.

Preferred embodiment of the present invention are hereinafter described in detail by reference to the following drawings which depicts in:

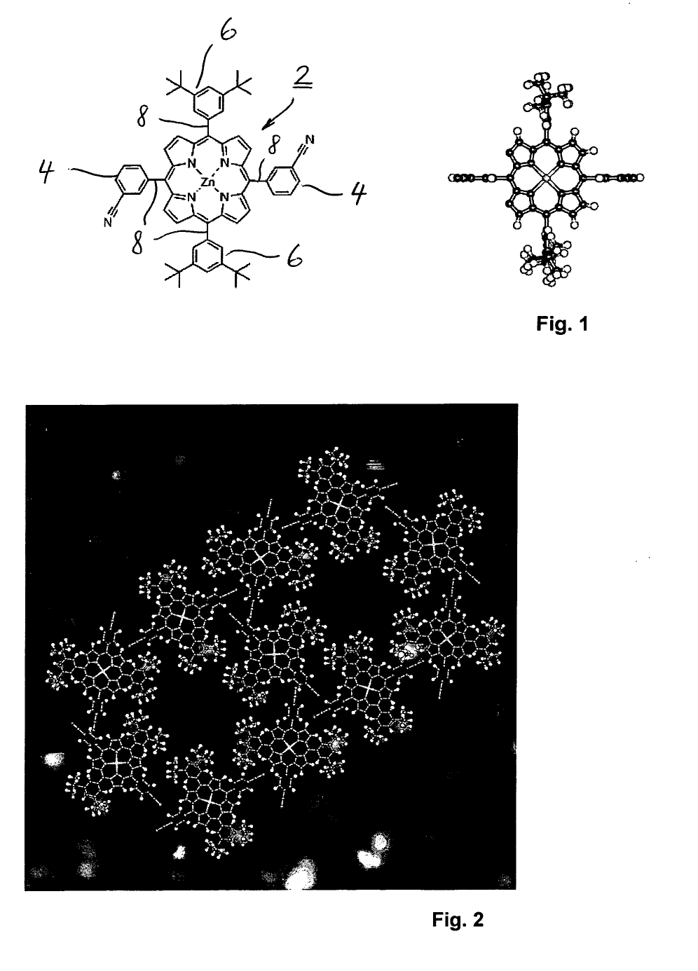

FIG. 1 the chemical structure of a porphyrin derivate used for the examples and embodiment hereinafter;

FIG. 2 a STM image of the porous nanostructure formed by the molecules of the porphyrin derivate according to claims 1;

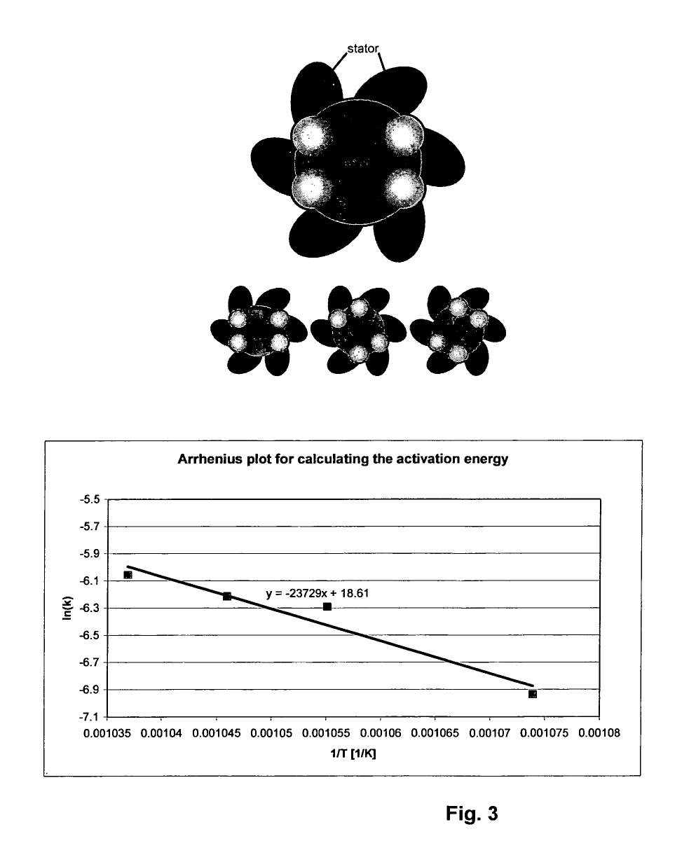

FIG. 3 a sketch of a single switch and its three possible positions within a nanopore center;

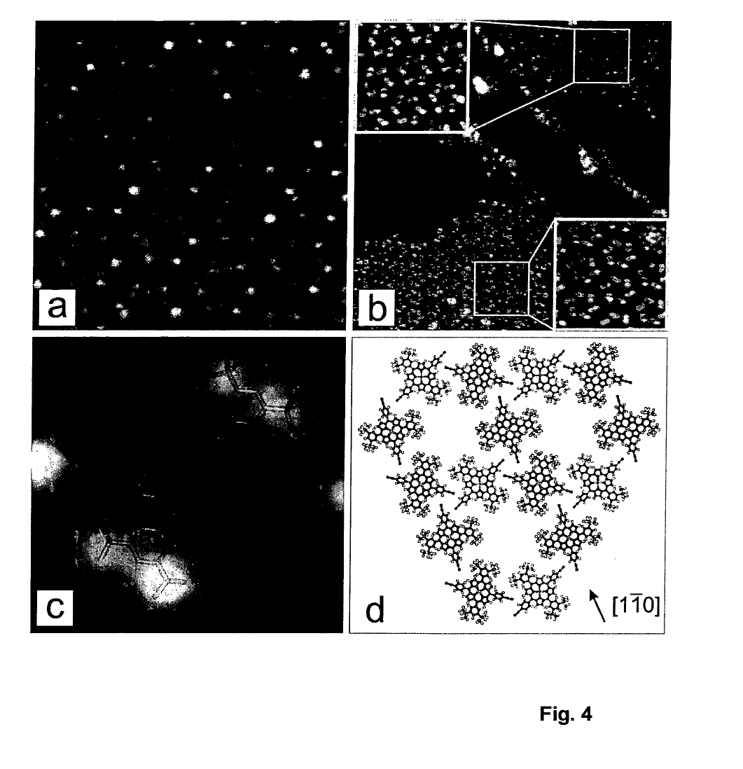

FIG. 4 STM images taken from a self-assembled network of the molecules of the porphyrin derivate according to FIG. 1;

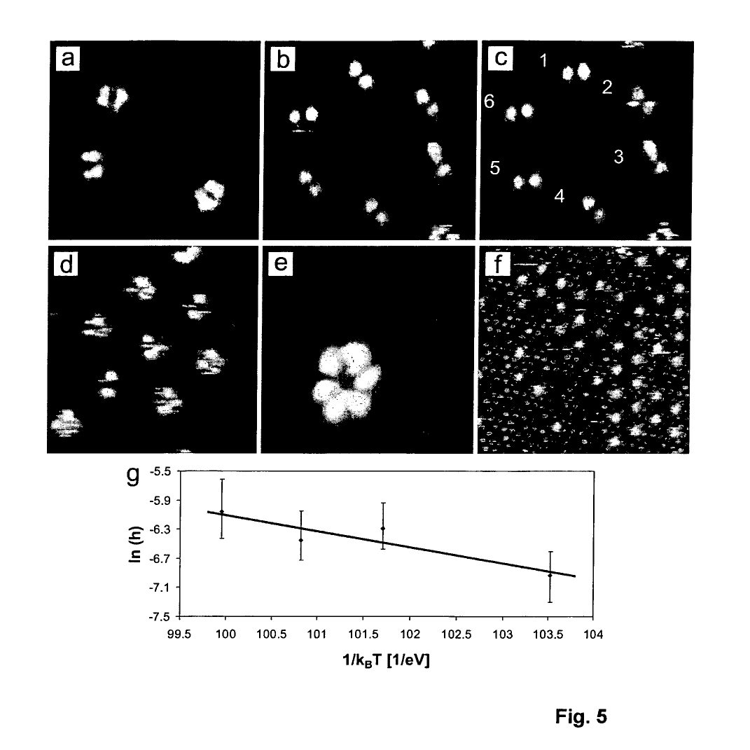

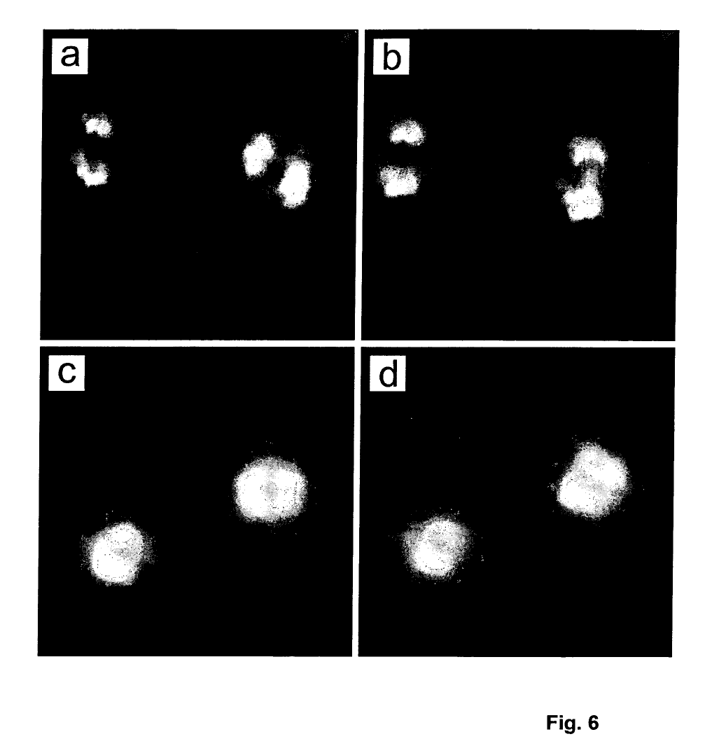

FIG. 5 STM images of the porphyrin network taken at different temperatures between 77 K and 298 K; and

FIG. 6 STM images of a rotation of a porphyrin molecule that occupies a nanopore center, said rotation being induced by an STM Tip;

FIG. 1 illustrates on the left side the chemical structure of a flexible porphyrin molecule 2 having special chemical sidegroup 4, 6. These sidegroups 4, 6 are rotatable around connecting bonds 8 to the porphyrin ring with sterically hindered rotation by steric interaction of the substituents. The image on the right side illustrates the ball and stick model of the same molecule.

These porphyrin molecules have been vapor-deposited under ultrahigh vacuum (UHV) conditions on an atomically clean and flat Cu(111) surface. At low coverage the porphyrins self-assemble into a two-dimensional porous network that was studied by STM at temperatures between 77 K and 297 K. As investigated by Scanning Tunneling Microscopy (STM), the resulting porous nanostructure is illustrated in FIG. 2. The porphyrins self-assemble in a hexagonal honeycomb pattern having nanopore centers which appear as dark sinks in the image. Overlayed is the tentatively assigned molecular arrangement of the used porphyrins, which could be shown to be in good agreement with the STM data. In interpreting the STM images, the hexagonal structure can be understood as stator and the porphyrin molecule within the nanopore center as a rotor which can have for physical reasons three possible positions (see FIG. 3). The activation energy that is required to thermally induce switching is calculated via an Arrhenius plot to be E_{A}=24±3 kJ/mol=0.24±0.03 eV what in shown is the lower part of FIG. 3.

FIG. 4 now illustrates STM images taken with V_{bias}=1.5 V, I=20 pA); a) STM image (scan range: 12.5×12.5 nm²) of a self-assembled network of porphyrin on an atomically clean Cu(111) surface. The network consists of chiral windmill-shaped nanopores with six wings each appearing as two bright dots. b) (50×50 nm², inlets: 9.1×9.1 nm²) The network can be found as two homochiral domains in which the wings point either clockwise or counterclockwise. c) (2.1×2.1 nm²)

Detailed view of a single molecule inside the porphyrin network. A transparent model of porphyrin is included to show the location of the molecule. d) Model of the network. Each pore consists of six molecules with the di-tert butyl groups building the wings of the windmill structure. Therefore, one molecule contributes to two neighboring pores.

FIG. 4a now depicts that in the STM images each nanopore center appears as a chiral windmill-shaped structure consisting of six wings. Each wing itself can be resolved by high resolution imaging into two separated spots. Because of the chirality of the pores one can find two homochiral domains where the wings are pointing either clockwise or counterclockwise (see FIG. 4b). Both domains can be found equally often. The two spots that form the windmill structure are associated with one of the di-tert butyl groups of a single molecule. The less bright structures between two parallel wings as shown in FIG. 4c are related to the porphyrin ring and the cyano-phenyl groups. Therefore, a single molecule in the network can be identified as a rectangle with bright spots on the edges and a mean side length of 4.0 Å for the smaller sides and 14.7 Å for the longer ones. Knowing this a tentative model of the network (see FIG. 4d) has been developed. It indicates that each nanopore center is surrounded by six flat lying molecules and that no part of the molecules can be found inside the nanopore centers. Each porphyrin is part of two opposing nanopore centers. The model shows that the cyano group of each cyano-phenyl group points to the center of the phenyl ring of the cyano-phenyl group of a neighboring molecule. The formation of the network is therefore driven by hydrogen bonds between the phenyl rings and the cyano groups.

FIG. 5 shows the following STM images: a) to f) STM images (V_{bias}=1.5 V, I=20 pA) of the porphyrin network taken at different temperatures between 77 K and 298 K. Some of the pores are filled. a) (scan range: 10.2×10.2 nm²) At 77 K the filling of the pore can be resolved into four rectangularly arranged spots. These can take three distinguishable positions all of which are shown. b) and c) (7.4×7.4 nm²) At 112 K only two spots are visible. They can switch to a different position over time (see especially structures 1 and 5). d) (8.8×8.8 nm²) At 115 K the filling appears fuzzy. e) (3.0×3.0 nm²) At 150 K all possible positions can be seen simultaneously leading to a flower-like appearance of the pore filling. f) (29.9×29.9 nm²) At room temperature some pores seem to be completely filled. g) Arrhenius-plot for the determination of the activation energy needed to switch between two neighboring positions. After further increasing the porphyrin coverage, at 77 K one could identify some of the nanopore centers being occupied by a structure consisting of four spots that in the STM images appeared much brighter than the underlying pore what is illustrated in FIG. 5a. While the supply of porphyrin molecules was absent at that stage the only explanation for this was self-trapping of the porphyrin molecules. The spots build a rectangle with a mean side length of 3.4 Å for the smaller sides and 8.1 Å for the longer ones. This structure shows a striking similarity to the appearance of a single molecule in the network (FIG. 4c), although the mean side length of the longer sides is almost 45% smaller.

Nevertheless, it is known that in STM images the inner-molecular distances can appear drastically reduced by a combination of molecule bending and a rotation of the di-tert butyl groups. Therefore, the conclusion was that these spots belong to one single porphyrin molecule trapped horizontally on top of a nanopore center. As the underlying nanopore center has a hexagonal symmetry the uplying molecule can take six different positions separated by a rotational angle of 60 degrees. Because of the symmetry of the molecule itself only three of these positions are distinguishable. In FIG. 5a three uplying molecules can be identified that lie in one of the three distinguishable positions each (as also shown in the sketch of FIG. 3).

After heating up to 112 K the uplying molecules appeared as two opposing spots (FIGS. 5b and c). This might be due to a thermally induced shivering of the di-tert butyl groups. While scanning successively the same area it has been discovered that the uplying molecules could switch thermally from one stable position into another. FIGS. 5b and c show two STM images of the same area taken directly one after the other (148 seconds per image). One can clearly see that molecules 1 and 5 have switched into a different position. The horizontal line in pore 2 indicates that the trapped molecule switched into a new position and then back while scanning the underlying nanopore center. Nevertheless, a tip induced rotation can be excluded as at a slightly lowered temperature of 110 K no rotation was observed. After careful inspection of the data a preferred rotational direction could not be found. Molecule 3 seems to be adsorbed into a position in which it is not able to rotate.

At a temperature of 115 K the structure of the uplying molecules appears very fuzzy (FIG. 5d) and at 150 K the fillings show a flower-like structure consisting of six leafs (FIG. 5e) what can be explained by the low imaging speed of the STM. At elevated temperatures the thermally induced rotation of the uplying molecules is much faster than the time-resolution of the STM. The molecules change their position while the STM tip scans over them making the imaging fuzzy. Above a certain rotation speed the STM image shows all positions a molecule can take in a single pore simultaneously leading to the shown flower-like structure. At room temperature even this structure disappeares and the pores seem to be completely filled as shown in FIG. 5f). From the analysis of successively taken STM images as described above at temperatures between 112 K and 116 K one was able to estimate the activation energy needed to switch one rotor. A model that is commonly used to describe diffusion of molecules on metal surfaces has been used. By counting the number of rotors that did not switch one obtained the switching rate h. Arrhenius plots of h as shown in FIG. 5g then lead to an activation energy of 0.28±0.03 eV with a pre-exponentional constant of 1×10^{9±2} s⁻¹. As the time resolution of the STM is low compared to the number of switching events as described above there have been events not to be resolved. Of course, there may also be switching to a new position and then back. Therefore, too many static rotors were counted especially at lower temperatures which leads to a lower switching rate. The activation energy obtained by this method must therefore be slightly to low.

FIG. 6 now illustrates by STM images that rotation of the uplying molecules can be induced by the STM tip. a) and b) (scan range: 5.4×5.4 nm², V_{bias}=1.55 V, I=19 pA) The molecule on the right was switched by the STM tip in constant current mode at 77 K. After the switching parts of the underlying pore look noisy. c) and d) (6.5×6.5 nm², V_{bias}=1.5 V, I=10 pA) Switching without disturbation of the pore can be induced by changing the applied current and voltage while the tip rests over the pore.

As the rotor is embedded into a nanoporous network its position is well known. Therefore, each switch can be selectively addressed and rotated by the STM tip. For this purpose the tip was placed over a switch and the parameters were adjusted to bring the tip close to the rotor. Then, it was circled in constant-current mode above the nanopore center with feedback still activated. FIGS. 6a and b show a successful selective switching event achieved by this method. The comparison with pores thermally switched (FIG. 5c) shows that after switching with the STM tip a part of the pore appeared to be noisy (FIG. 6b). This indicates that the tip-induced energy is slightly larger than the energy needed for a rotation and that therefore pore molecules are excited. This effect was observed after most circling tip switching events.

To induce energy more precisely an alternative method was used. Two sets of tip-parameters were defined, one with a higher voltage (1.5 V) and lower current (10 pA) and one with a lower voltage (700 mV) and a higher current (150 pA). The first set was applied to place the tip over a nanopore center where switching should be induced. Then, the second set was activated for approximately one second with feedback still activated. FIGS. 6c and d show an example where precise tip-switching was applied to the switch in the right part of the image. One can clearly see that the uplying molecule switched into a different position while the switch on the left did not rotate. A disturbance of the stator could not be observed. Although this method has a high probability of success the direction of rotation for the switch cannot be predicted.

The found molecular rotor has shown to be a very flexible and powerful nanodevice. It consists of only seven equal porphyrin molecules. The underlying nanopore consisting of six molecules serves simultaneously as stator. The rotor is build out of a single uplying porphyrin molecule. Starting at a temperature of 112 K the rotor rotates by thermal energy. Because of its six quantized positions it can be seen as a brownian ratchet although unidirectional movement could not be observed. At lower temperatures the rotation can be externally induced by an electrical current. The device therefore reminds of a mechanical rotary switch that might one day be used as a gate to switch between different molecular wires. The same characteristic in connection to the well known positioning in a molecular array makes the rotary switch a promising candidate for a molecular mass storage device that has even three distinguishable and stable states. Because of the bottom-up building approach all devices show the same characteristics and are atomically equal. The amount of defects is very small compared to using nowadays top-down approach to manufacture similarly sized structures. Detrition has never been observed and is not to be expected. Therefore, the successful design of the molecular rotary switch can be seen a breakthrough in nanoscale devices and molecular electronics.

1-31. (canceled)

32. A method for generating a porous network of supra-molecular devices, comprising the following method steps:
providing self-organizing molecules formed with connecting bonds and side-groups;
generating a two-dimensional layer of the molecules on an unstructured surface, wherein the molecules self-organize and self-organizing leads to an at least partially regular network of cells, with each cell including a plurality of the self-organizing molecules and each cell defining a functional center; and
further depositing a predefined amount of molecules on the two-dimensional layer, wherein the further-deposited molecules locate in the functional centers of the cells, one or more of the further-deposited molecules per cell, and wherein the further-deposited molecule together with the cell hosting the further-deposited molecule form a multi-stable architecture.

33. The method according to claim 32, wherein the further-deposited molecules are selected from the group consisting of the self-organizing molecules and other functional molecules.

34. The method according to claim 32, wherein the multi-stable architecture enables at least two different states of the further deposited molecule together with the hosting cell as defined by properties selected from the group consisting of electronic properties, mechanical properties, opto-electronic properties, and opto-mechanical properties.

35. The method according to claim 32, wherein the multi-stable architecture is defined by the side-groups which, upon stimulation, rotate about the connecting bonds.

36. The method according to claim 32, wherein the self-organizing molecules are selected from the group of molecules consisting of porphyrin, porphyrin derivates, coronenes, coronene derivates, phtalo-cyanines, phtalo-cyanine derivates, deca-cyclines, and deca-cycline derivates.

37. The method according to claim 32, wherein the side groups that offer circular binding of the molecules are either polar groups, hydrogen bonds, multipolar interactions, halogen bonding, or quadropolar interactions.

38. The method according to claim 37, wherein the providing step comprises providing specially designed porphyrin molecules configured to arrange in a way that the polar group of a side-group of one porphyrin molecule points to a polar group of a side-group of a neighboring porphyrin molecule.

39. The method according to claim 38, wherein the side group is a cyano-phenyl group, with a cyano group of each cyano-phenyl group of a porphyrin molecule pointing to a center of the phenyl ring of the cyano-phenyl group of a neighboring porphyrin molecule.

40. The method according to claim 32, which comprises selecting the unstructured surface from the group consisting of metallic surfaces, ionic surfaces, ceramic surfaces, glass surfaces, and mixtures of the foregoing surfaces.

41. The method according to claim 40, wherein the unstructured surface is a metallic crystal surface with a [001] or a [111] orientation.

42. The method according to claim 40, wherein the unstructured surface is a Cu surface.

43. The method according to claim 40, wherein the unstructured surface is an ionic crystalline NaCl and/or KCl surface.

44. The method according to claim 40, wherein the unstructured surface is a silicon surface.

45. The method according to claim 44, wherein the silicon surface is a surface passivated by hydrogen fluoride.

46. The method according to claim 32, which comprises switching an orientation of a molecule accommodated in the nanopore center by way of an electric stimulation of the molecule at or below a predefined temperature.

47. The method according to claim 46, which comprises stimulating the molecule with SPM, by inducing energy with an SPM tip sensor.

48. The method according to claim 46, which comprises stimulating the molecule with an STM tip sensor.

49. The method according to claim 32 which comprises adjusting the amount of the further-deposited molecules to less or equal to an amount necessary for creating one mono-layer.

50. A porous network of supra-molecular devices, comprising:
a two-dimensional layer of self-organizing molecules having connecting bonds and side-groups disposed on an unstructured surface;
said molecules being self-organized in an at least partially regular network of cells each having a plurality of said self-organizing molecules and each offering a functional center; and
a predefined amount of functional guest molecules deposited on said two-dimensional layer and accommodated in said functional centers of said cells, with one or more of said guest molecules per cell;
said further-deposited guest molecule defining a multi-stable architecture together with a respective said cell hosting said further-deposited guest molecule.

51. The network according to claim 50, wherein said self-organizing molecules are selected from the group consisting of porphyrin, porphyrin derivates, coronenes, coronene derivates, phtalo-cyanines, phtalo-cyanine derivates, deca-cyclines, and deca-cycline derivates.

52. The network according to claim 50, wherein said side groups offering circular binding of the molecules are either polar groups or hydrogen bonds.

53. The network according to claim 51, wherein said self-organizing molecules are specially designed porphyrin molecules configured to arrange in a way that a polar group of a side-group of one porphyrin molecule points to a polar group of a side-group of a neighboring porphyrin molecule.

54. The network according to claim 53, wherein said side group is a cyano-phenyl group and a cyano group of each said cyano-phenyl group of a porphyrin molecule points to a center of the phenyl ring of the cyano-phenyl group of a neighboring porphyrin molecule.

55. The network according to claim 46, wherein said unstructured surface is selected from a group consisting of metallic surfaces, ionic surfaces, ceramic surfaces, glass surfaces, and mixtures of the foregoing surfaces.

56. The network according to claim 55, wherein said unstructured surface is a metallic crystal surface with a [001] or a [111] orientation.

57. The network according to claim 55, wherein said unstructured surface is a Cu surface.

58. The network according to claim 55, wherein said unstructured surface is an ionic crystalline NaCl and/or KCl surface.

59. The network according to claim 55, wherein said unstructured surface is a silicon surface.

60. The network according to claim 55, wherein said unstructured surface is a silicon surface passivated by hydrogen fluoride.

61. The network according to claim 50, wherein an orientation of the molecule accommodated in the nanopore center is switched by an electric stimulation of said molecule at a predefined temperature or at a temperature below a predefined temperature.

62. The network according to claim 61, wherein said molecule is SPM stimulated by inducing energy with an SPM tip.

63. The network according to claim 62, wherein said molecule is SPM stimulated by inducing energy with an STM tip.

64. The network according to claim 50, wherein the amount of said further-deposited guest molecules is less than or equal to an amount necessary to form one mono-layer.

65. An information storing method, which comprises:
producing a porous network of supra-molecular devices according to claim 32; and
utilizing the multi-stable architecture for storing information in the network of supra-molecular devices.

66. A method of generating intelligent functional surfaces, which comprises: providing a porous network of supra-molecular devices generated according to the method of claim 32 and generating intelligent functional surfaces with switching surface for transport, reflectivity, emissivity or absorption purposes taking benefit from the multi-stable architecture.

67. A method of storing information, which comprises providing a porous network of supra-molecular devices having a multi-stable architecture and storing the information taking benefit from the multi-stable architecture.

68. A method of generating intelligent functional surfaces, which comprises using a porous network of supra-molecular devices for the purpose of generating intelligent functional surfaces with switching surface for transport, reflectivity, emissivity or absorption purposes taking benefit from the multi-stable architecture.
